(19) United States
(12) Patent Application Publication
(10) Pub. No.: US 2021/0244023 A1
(43) Pub. Date: Aug. 12, 2021

(54) COMPOSITIONS CONTAINING MICROENCAPSULATED ORGANIC COMPOUNDS

(71) Applicant: THE UNITED STATES OF AMERICA, AS REPRESENTED BY THE SECRETARY OF AGRICULTURE, Washington, DC (US)

(72) Inventors: Sanghoon KIM, Peoria, IL (US); Patrick F. DOWD, Peoria, IL (US)

(21) Appl. No.: 16/973,292

(22) PCT Filed: Jun. 5, 2019
(86) PCT No.: PCT/US2019/035523

§ 371 Date: Dec. 8, 2020

Related U.S. Application Data
(60) Provisional application No. 62/682,320, filed on Jun. 8, 2018.

(51) Int. Cl. A01N 25/28; A01N 43/16; A01N 43/54; A01N 57/12; A01N 47/34; A01N 37/08; A01N 47/22; A01N 43/90

(52) U.S. Cl. CPC A01N 25/28; A01N 43/16; A01N 43/54; A01N 43/90; A01N 47/34; A01N 37/08; A01N 47/22; A01N 57/12

(57) ABSTRACT

The present invention relates to compositions of microencapsulated organic compounds, such as pesticides, including insecticides, and methods of making and using the microcapsules. Encapsulating materials include proteins and degradable polymers. These microencapsulated organic compounds provide, for example, increased effective working time of pesticides, resulting in lowered need for reapplication of the pesticides.

### CROSS-REFERENCE

The present application claims priority to U.S. Provisional Patent Application Ser. No. 62/682,320 filed Jun. 8, 2018, the content of which is expressly incorporated herein by reference.

### BACKGROUND OF THE INVENTION

### Field of Invention

The present invention relates to compositions of microencapsulated organic compounds, such as pesticides and methods of making and using the microcapsules. Encapsulating materials include proteins and degradable polymers. These microencapsulated organic compounds provide, for example, increased effective working time of pesticides, resulting in lowered need for reapplication of the pesticides for example on plants.

### Background

The effective working time of pesticides, including insecticides, is limited by weather conditions because the sprayed insecticides are washed away with rain. Insecticides need to remain on the surface of plants until the target insects are fully controlled. Premature removal of insecticides from plant leaves requires reapplication of insecticides multiple times that calls for more labor, time, and expenditure. It is also important to avoid multiple applications of insecticides to avoid detrimental environmental impact. Therefore, it was our goal to develop insecticides encapsulated into tiny particles that adhere on the surface of leaves and are not washed away with rain. Herein, we describe compositions and methodologies to meet this need.

### SUMMARY OF THE INVENTION

One embodiment of the disclosure provided herein is a composition comprising a microencapsulated organic compound, where the microencapsulated organic compound comprises a core material comprising the organic compound and a microcapsule having a protein shell wall surrounding the core material and where a degradable polymer is attached to the shell wall. In some embodiments, the organic compound is a pesticide (including insecticides), such as an insect growth regulator, a chitin synthesis inhibitor, a macrocyclic lactone pesticide, an organophosphate pesticide, a carbamate pesticide, or a pyrethroid pesticide. In specific embodiments, the pesticide is abamectin, spinosad, spinetoram, hydramethylnon, malathion, diflubenzuron, allethrin, carbaryl, or mixtures thereof. In some embodiments, the organic compound does not dissolve in water and is soluble in an organic solvent, wherein the organic solvent is not miscible in water. In some embodiments, the organic compound is a liquid that does not mix with water. In additional embodiments, the protein utilized is a protein from plant, animal, microbial, or synthetic origin, such as bovine serum albumin or glycinin. In a specific embodiment the degradable polymer comprises poly(alkyl cyanoacrylate). In preferred embodiments, the organic compound is miscible in an organic solvent. In specific embodiments, the organic solvent is water-immiscible. In specific embodiments, the organic solvent is dichloromethane or butyl acetate.

Another embodiment provided herein is microparticles comprising an organic compound core material microencapsulated in a protein shell wall, where a degradable polymer is attached to the shell wall, and where the microparticles are produced by the following steps: (a) preparing a solution of the organic compound in a first organic solvent to produce a solution of the organic compound; (b) adding a second organic solvent to water and stirring the mixture to saturate the water with the second organic solvent; (c) adding the solution of the organic compound to the water saturated with the second organic solvent to generate phase-separated droplets; (d) adding a protein solution to the phase-separated droplets under conditions effective to encapsulate the droplets by the protein, thereby forming a protein shell wall; (e) adding monomers of the degradable polymer to the protein-encapsulated droplets under conditions effective to allow formation of the degradable polymer attached to the protein shell wall; and (f) recovering the microparticles. In some embodiments the first and second organic solvents are the same organic solvent. In specific embodiments, the first organic solvent is dichloromethane or butyl acetate. In some embodiments, the organic compound is a pesticide (including insecticides), such as an insect growth regulator, a chitin synthesis inhibitor, a macrocyclic lactone pesticide, an organophosphate pesticide, a carbamate pesticide, or a pyrethroid pesticide. In specific embodiments, the pesticide is abamectin, spinosad, spinetoram, hydramethylnon, malathion, diflubenzuron, allethrin, carbaryl, or mixtures thereof. In additional embodiments, the protein utilized is a protein from plant, animal, microbial, or synthetic origin, such as bovine serum albumin or glycinin. In a specific embodiment the degradable polymer comprises poly(alkyl cyanoacrylate).

Further provided are methods of making the microencapsulated organic compounds described herein, comprising the steps of: (a) preparing a solution of the organic compound in a first organic solvent to produce a solution of the organic compound; (b) adding a second organic solvent to water and stirring the mixture to saturate the water with the second organic solvent; (c) adding the solution of the organic compound to the water saturated with the second organic solvent to generate phase-separated droplets; (d) adding a protein solution to the phase-separated droplets under conditions effective to encapsulate the droplets by the protein, thereby forming a protein shell wall; (e) adding monomers of the degradable polymer to the protein-encapsulated droplets under conditions effective to allow formation of the degradable polymer attached to the protein shell wall; and (f) recovering the microparticles. In some embodiments of this method, the first and second organic solvents are the same organic solvent. In specific embodiments, the first organic solvent is dichloromethane or butyl acetate. In some embodiments, the organic compound is a pesticide (including insecticides), such as an insect growth regulator, a chitin synthesis inhibitor, a macrocyclic lactone pesticide, an organophosphate pesticide, a carbamate pesticide, or a pyrethroid pesticide. In specific embodiments, the pesticide is abamectin, spinosad, spinetoram, hydramethylnon, malathion, diflubenzuron, allethrin, carbaryl, or mixtures thereof. In additional embodiments, the protein utilized is a protein from plant, animal, microbial, or synthetic origin, such as bovine serum albumin or glycinin. In a specific embodiment the degradable polymer comprises poly(alkyl cyanoacrylate).

Still another embodiment of the present disclosure provides method of killing an insect, comprising the steps of: (a) applying a microencapsulated pesticide described herein to a plant surface, thereby adsorbing the microencapsulated pesticide to the plant surface; and (b) allowing an insect to ingest or absorb the microencapsulated pesticide in an effective amount to kill the insect. In some embodiments, the organic compound is a pesticide (including insecticides), such as an insect growth regulator, a chitin synthesis inhibitor, a macrocyclic lactone pesticide, an organophosphate pesticide, a carbamate pesticide, or a pyrethroid pesticide. In specific embodiments, the pesticide is abamectin, spinosad, spinetoram, hydramethylnon, malathion, diflubenzuron, allethrin, carbaryl, or mixtures thereof. Plant surfaces include, but are not limited to, a leaf surface, a stem surface, a flower surface, a root surface, a tuber surface, or a seed surface. In some embodiments of this method, exposure of the plant surface to water following adsorption of the microencapsulated pesticide does not result in removal of the effective amount of the microencapsulated pesticide.

### INCORPORATION BY REFERENCE

All publications, patents and patent applications mentioned in this specification are herein incorporated by reference to the same extent as if each individual publication, patent or patent application was specifically and individually indicated to be incorporated by reference.

### BRIEF DESCRIPTION OF THE DRAWINGS

The novel features of the invention are set forth with particularity in the claims. Features and advantages of the present invention are referred to in the following detailed description, and the accompanying drawings of which:

FIG. 1 provides a schematic of the preparation process of spinosad-carrying microcapsules. Bovine serum albumin (BSA) (small circles) surround the core material (spinosad), then ethyl cyanoacrylate (ECA) (wavy lines) is polymerized on the BSA.

FIG. 2 provides a representation of data showing hydrodynamic diameter (open circles) and polydispersity (filled circles) of prepared microparticles at different dichloromethane/BSA ratio (wt/wt).

FIG. 3 provides a representation of data showing the encapsulation efficiency of microcapsules at different dichloromethane/BSA ratio (wt/wt).

FIG. 4A and FIG. 4B provide optical microscopic images of adsorbed microcapsules on the surface of a glass plate. FIG. 4A shows the glass plate before rinsing with water. FIG. 4B shows the same glass plate after rinsing with water.

### DETAILED DESCRIPTION OF THE INVENTION

Provided in the present disclosure are methodologies for the encapsulation of organic compounds (e.g., pesticides and insecticides, such as spinosad) into microparticles. In some embodiments, the pesticide is dissolved in an organic solvent that does not mix with water. In aqueous solvent medium, such organic solutions are separated into micrometer-scale droplets that are subsequently surrounded by encapsulating materials, for example protein-polycyanoacrylate block copolymers. In some embodiments, the encapsulating materials allow the microparticles to be adsorbed irreversibly on a plant surface, such as plant leaves. As an exemplar of this approach, detailed herein are procedures for the preparation of spinosad-containing microcapsules, as well as demonstrations of their surface-binding properties.

Preferred embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby.

Technical and scientific terms used herein have the meanings commonly understood by one of ordinary skill in the art to which the instant invention pertains, unless otherwise defined. Reference is made herein to various materials and methodologies known to those of skill in the art.

Any suitable materials and/or methods known to those of skill can be utilized in carrying out the instant invention. Materials and/or methods for practicing the instant invention are described. Materials, reagents and the like to which reference is made in the following description and examples are obtainable from commercial sources, unless otherwise noted.

As used in the specification and claims, use of the singular “a”, “an”, and “the” include plural references unless the context clearly dictates otherwise.

The terms isolated, purified, or biologically pure as used herein, refer to material that is substantially or essentially free from components that normally accompany the referenced material in its native state.

The term “about” is defined as plus or minus ten percent of a recited value. For example, about 1.0 g means 0.9 g to 1.1 g and all values within that range, whether specifically stated or not.

Microencapsulation

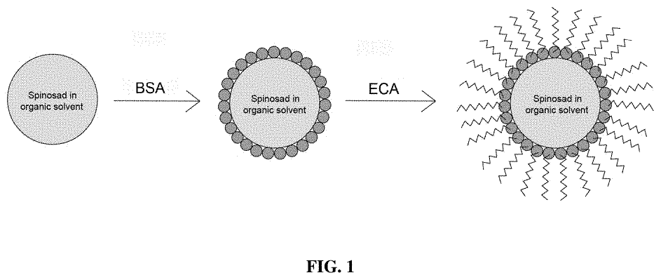

Microencapsulation is a technique by which solid, liquid or gaseous components are packaged within a second, third, and/or fourth material for the purpose of shielding the internal component from the surrounding environment. Typically, the internal component is designated as a core material and the surrounding material forms a shell (see, e.g., FIG. 1). This general microencapsulation technique has been employed in a diverse range of fields, generating widespread interest in this technology. Microcapsules can be classified based on their size and morphology. An important feature of microcapsules is that their microscopic size allows for a large surface area relative to size, being roughly inversely proportional to the diameter, allowing for sites of adsorption, desorption and chemical reactions.

Microcapsules typically range in size from 0.1 to 100 μm in diameter. Some microcapsules with sizes in the nanometer range can be referred to as nanocapsules, distinguished only by size from the larger microcapsules. Microcapsules are also characterized by their morphology into three basic categories—monocored, polycored and matrix microcapsules. Monocore microcapsules have a single chamber within the shell, usually comprising the active ingredient(s). Polycore microcapsules contain multiple chambers with the shell with each chamber containing multiple distinct ingredients, or the same ingredient. Matrix microcapsules have the active ingredient(s) integrated within the shell material.

A variety of techniques of microencapsulation are known in the art and can be divided into two broad categories: 1) those in which the starting materials include monomers or prepolymers and chemical reactions are involved along with microsphere formation resulting in polymer production; and 2) those in which the starting materials are polymers and only the formation of the microcapsule takes place during production. The choice of microencapsulation methodology depends on the nature of the polymeric/monomeric shell materials to be utilized. For example, poly(alkyl cyanoacrylate) nanocapsules can be obtained by emulsion polymerization (Damge et al., J. Pharm Sci., (1997) 86:1403-9). Other techniques known in the art include, but are not limited to, interfacial polycondensation, solvent evaporation/extraction, suspension crosslinking, spray drying, fluidized bed coating, melt solidification, coacervation/phase separation, polymer precipitation, co-extrusion, spinning disk, supercritical fluid expansion, and layer-by-layer deposition.

In general, the encapsulated organic compounds of the present invention are prepared by dissolving organic compounds (either in the form of solid or liquid) in an organic solvent that undergoes phase separation with water. The prepared solution is dispersed in water in the form of small droplets when the solution was vigorously stirred. These small droplets become even smaller when protein molecules are added to the solution subsequently because protein molecules work as an emulsifier. As a result, tiny liquid droplets surrounded by protein molecules are prepared. Subsequent addition of alkyl cyanoacrylate monomers to this solution induces growth of poly(alkyl cyanoacrylate) on the surface of each droplet. As a result, each droplet is surrounded by protein-polyacyanoacrylate block copolymers. Thus, the microparticles of the present invention are prepared.

Particle size variation of the microcapsules of the present invention can be achieved by varying the composition, as described above, and by controlling the reaction conditions such as, for example, blending speed, shear forces, mixer design and mixing times. In general, reduced blending speed, shear forces and mixing time favor the preparation of larger microcapsules.

The preferred range for particle size is larger than 100 nm to carry sufficient amounts of encapsulated organic compounds, but smaller than 1 μm to obtain stable suspension. The size of particles can be altered by techniques known to those of skill in the art, for example, by the choice/amount of organic solvent, protein, and degradable polymer (e.g., alkyl cyanoacrylate).

Encapsulated (Core) Materials

The present disclosure contemplates the inclusion of any core material that does not dissolve in water (solids) and is soluble in an organic solvent that is also not miscible with water, or the core material is a liquid that does not mix with water. One of skill in the art will recognize that this includes many organic compounds, including biopesticides (e.g., avermectin, garlic oil, insecticidal soaps, limonene, neem, plant-derived horticultural oils, nicotine, pyrethrum, rotenone, ryanoid, ryanodine, sabadilla and spinosad); and synthetic pesticides (e.g. allethrin, Amdro® (hydramethylnon), carbaryl, cartap, chromafenozide, cyromazine, diflubenzuron, dimetilan, DNOC, etoxazole, fenoxycarb, flucofuron, indoxacarb, imidacloprid, ivermectin, malathion, methoxychlor, spinetoram, and spiromesifen). Based on these examples, one of skill in the art will understand that the specifically recited compounds indicate the applicability of the present invention to use with broad categories of pesticides/insecticides, such as insect growth regulators, chitin synthesis inhibitors, macrocyclic lactone pesticides, organophosphate pesticides, carbamate pesticides, pyrethroid pesticides, and other categories, whether naturally occurring or synthetic.

One example of an encapsulated (core) material is spinosad, which is a natural substance made by a soil bacterium that is toxic to insects. It is a mixture of two chemicals called Spinosyn A and Spinosyn D (Stebbins et al, Toxicol. Sci., (2002) 65:276-87). Spinosad contains 90% spinosyns and about 10% residual materials from the fermentation broth. The spinosyn component is about 85% spinosyn A and 15% spinosyn D with other spinosyns as minor impurities. Empirical Formula of Spinosyn A is C₄₁H₆₅NO₁₀ (MW 731.98), while that of Spinosyn D is C₄₂H₆₇NO₁₀ (MW 745.99). Chemically, spinosyns are macrocyclic lactones with two sugars attached, one to the lactone ring and the other to a complex 3-ring structure. Spinosyn D has one more methyl group than Spinosyn A. In the case of Spinosyn A, it has been synthesized in the lab (Bal et al, J. Am. Chem. Soc., (2016) 138:10838-41). Pure forms of spinosyns are not commercially available in large quantity as these materials are natural products.

In embodiments of the present disclosure, pesticides, such as spinosad, can be incorporated into microcapsules along with other materials useful in agricultural settings such as fungicides, herbicides, repellants, attractants, phagostimulants and the like. Such other materials or compounds (e.g., insect attractants known in the art) may be added to the composition provided they do not substantially interfere with the intended activity and efficacy of the composition; whether a compound interferes with activity and/or efficacy can be determined, for example, by the procedures utilized below.

Encapsulating (Shell) Materials

The microcapsule shell can comprise any suitable protein known in the art, as BSA, soy proteins (e.g., glycinin) and lysozyme. Degradable polymers are attached to the protein shell wall and include a variety of aliphatic-cyanoacrylates. As used herein, the term aliphatic-cyanoacrylates encompasses both alkyl-cyanoacrylates and alkenyl-cyanoacrylates. Aliphatic-cyanoacrylates which are suitable for use herein may also be referred to as aliphatic-2-cyanoacrylates, and are of the formula CH₂:C(CN)COOR, wherein R is an aliphatic hydrocarbon moiety, which may be a branched or straight chain, saturated or unsaturated, and optionally substituted. In a preferred embodiment, R is a C1 to C8 aliphatic hydrocarbon, more preferably a C1 to C8 alkyl moiety. Particularly preferred aliphatic-cyanoacrylates for use herein include, but are not limited to, methyl-2-cyanoacrylate, ethyl-2-cyanoacrylate, n-propyl-2-cyanoacrylate, isopropyl-2-cyanoacrylate, n-butyl-2-cyanoacrylate, isobutyl-2-cyanoacrylate, n-pentyl-2-cyanoacrylate, isopentyl-2-cyanoacrylate, 3-acetoxypropyl-2-cyanoacrylate, 2-methoxypropyl-2-cyanoacrylate, 3-chloropropyl-2-cyanoacrylate, alkenyl-2-cyanoacrylates, alkoxyalkyl-2-cyanoacrylates or combinations thereof. It will be understood by the skilled artisan that these specific components are provided as examples and are not intended to be an exhaustive list of components that can be utilized to practice the present disclosure.

In general, the degradable polymers are attached to the protein shell material via the amine groups on the protein. The amine groups on the surface of the proteins work as an initiator for the polymerization of the degradable polymer monomers (e.g., alkyl cyanoacrylate). As a result of the polymerization reaction, a degradable polymer (e.g., poly(alkyl cyanoacrylate)) molecules are attached to the protein shell.

Having generally described this invention, the same will be better understood by reference to certain specific examples, which are included herein to further illustrate the invention and are not intended to limit the scope of the invention as defined by the claims.

### EXAMPLES

### Example 1

Material Preparation

Spinosad Preparation.

Entrust® SC 5 g was thoroughly mixed with 30 g water and 70 g ethanol was added subsequently. The floating gummy materials were removed by centrifuging at 10 k×g for 3 min. The supernatant was mixed with 150 mL dichloromethane, shaken vigorously, and stood overnight. The phase-separated top layer was discarded and 50 g water and 20 g ethanol was added to the bottom layer. The whole mixture was shaken vigorously and stood for 4-5 hrs. Top layer was discarded and 50 mL acetonitrile was added to the bottom layer. After that, most organic solvents were removed by using Rotavap. Small amount of water was added to the solution and freeze-dried to obtain spinosad powder.

High performance liquid chromatography (HPLC) was used for the evaluation of extracted spinosad from Entrust® SC (Zhao et al., Bull. Environ. Contam. Toxicol., (2007) 78:222-25). The chromatogram of analytical-standard spinosad was compared with that of the freeze-dried spinosad which was obtained from Entrust® SC by the procedure specified in the previous section. These spinosad samples were dissolved in 80% acetonitrile to make 0.2% solution. The HPLC system consisted of an Agilent Series 1100 HPLC system (Santa Clara, Calif., USA) with a diode array detector that allowed five wavelength settings. A Luna 5μ C₁₈(2) reverse-phase column (250 mm×4.60 mm I.D.) (Phenomenex, Torrance, Calif., USA) was eluted isocratically with 75% acetonitrile/25% 10 mM ammonium acetate as the mobile phase at a flow-rate of 1.5 ml/min. Typical injection volume was 10 μL and the column temperature was kept at 35° C. The purity of spinosad extracted from Entrust SC was examined by comparing its HPLC chromatogram with that of the analytical-standard spinosad.

Data were examined for statistically significant differences using Chi square analysis with the SAS program Proc Freq, Version 8.0.

Microcapsule Preparation and Measurement.

Dichloromethane was added to 10 g water while vigorously stirring the mixture until phase-separated droplets begin to appear. 0, 0.1, 0.2, 0.3, 0.4, 0.5, 0.6, or 0.7 g of 5% spinosad solution in dichloromethane was added to the previously prepared dichloromethane/water mixture while stirring vigorously. Then, 0.5 g of 6% BSA solution was added to this solution and stirred for 5 minutes. 4N hydrochloric acid was added to lower the pH of the solution to 2, and 30 μL of ECA was added subsequently. The reaction mixture was closed tightly and stirred overnight. This reaction yielded spinosad-containing microcapsule suspensions. These reaction products were used for the dynamic light scattering (DLS) experiments described in the next section. The above-mentioned product also contained unencapsulated spinosad. Encapsulated spinosad was isolated by adding 1 g sodium chloride to the reaction product to induce aggregation of microcapsules. Then, it was centrifuged for 5 min at 10 k×g to separate the precipitates from the solution. The collected precipitates were suspended in 30% aqueous ethanol solution.

Microcapsules were prepared from the emulsion droplets in aqueous solution. Since spinosad is a solid, it was solubilized in an organic solvent, dichloromethane. This water-immiscible organic solvent that contains spinosad was dispersed in aqueous solution, and they were surrounded by protein (BSA). Because of the amphiphilic nature of BSA molecules, the emulsion droplets surrounded by this protein were stabilized in the solution. Without the addition of protein, the emulsion droplets merged to large droplets and eventually the whole solution was separated into two phases, organic solvent layer and water layer. Subsequently added ECA monomers were polymerized to form poly(ethyl cyanoacrylate) (PECA) on the surface of BSA because the amine groups of BSA act as initiator for the polymerization reaction of ECA. As a result of this reaction, each emulsion droplet was surrounded by block copolymers comprised of BSA and PECA. The schematic of the preparation procedure of microcapsules is illustrated in FIG. 1.

Particle Size.

Dynamic light scattering (DLS) experiments were carried out with the dispersions using a Particle Size Analyzer equipped with a 640 nm diode laser and an avalanche photodiode detector (Model 90 Plus, Brookhaven Instruments Corporation, Holtsville, N.Y., USA). All the samples were diluted twenty times with the same solvent and measurements were performed after filtering the solution with 2.7 μm filter. All measurements were done at a 90° detection angle at 23° C. For each sample, ten DLS measurements were conducted and each run lasted 5 s. All measurements were processed using the software supplied by the manufacturer (9kpsdw, v.5.31), which provided the mean hydrodynamic diameter via a multimodal analysis. This measurement was repeated six times for each sample for the statistical treatment of data.

The size of emulsion droplets was dependent on the viscosity of the solution medium, interfacial tension between droplet and surrounding liquid medium, shear rate (stirring speed), and presence of a surfactant (including polymeric amphiphiles such as proteins). These factors are again dependent on the temperature of the system. To form stable emulsions, the dispersed particle sizes need to be less than one micrometer in diameter and smaller particles are more stable than larger ones. The actual size of particles can be measured with DLS. As a result of this experiment, it is expected to obtain the optimum ratio for dichloromethane/BSA (wt/wt) for the preparation of particles. For that purpose, we tested a fixed amount of BSA while varying the amount of organic solvent (i.e., dichloromethane). To monitor the encapsulation of spinosad into the particles, 5% spinosad solution in dichloromethane was used instead of pure dichloromethane. It should be noted that a part of spinosad migrates from dichloromethane droplets to the surrounding aqueous medium during the preparation process because spinosad is slightly soluble in water. Therefore, the spinosad-encapsulation efficiency cannot be 100%, but is dependent on the microcapsule preparation conditions.

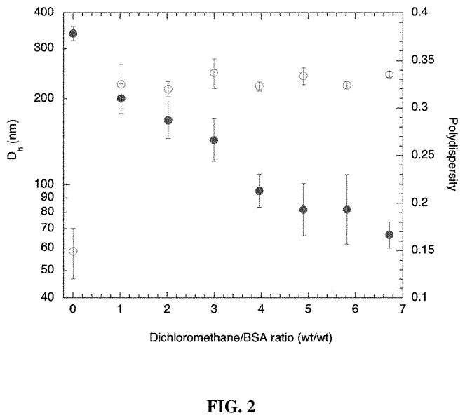

The procedure for the preparation of test samples is described above, but to determine optimally low polydispersity (high homogeneity), the amount of 5% dichloromethane is a variable while the amount of protein (i.e., BSA) is fixed. The obtained DLS data are shown in FIG. 2. These data show that the size of produced particles was not much changed throughout the variation of dichloromethane/BSA ratio. The size of produced particles is in the range of 220-260 μm. On the other hand, the size of particles produced without adding the dichloromethane (i.e., reaction product of BSA and ECA) was ˜60 nm. In this case, the reaction product did not form emulsion particles, but a suspension. Unlike hydrodynamic diameter, polydispersity decreases as more dichloromethane was added. Together with the data for hydrodynamic diameter, it was concluded that the BSA molecules that are not incorporated into shells surrounding dichloromethane droplets react with ECA and form smaller particles than emulsion droplets but which are polydisperse in their size distribution. This happens at low dichloromethane/BSA ratio. As this ratio is increased (>4), the size distribution of particles in the product became close to homogeneous (i.e., low polydispersity). Therefore, optimum dichloromethane/BSA ratio for the preparation process is with a higher than 4 in FIG. 2.

Encapsulation Efficiency.

Encapsulation efficiency was calculated by measuring the amount of spinosad that was not encapsulated in the prepared solution by taking UV spectra with a UV spectrophotometer (Shimadzu UV-2600, Kyoto, Japan) equipped with 1.0 cm quartz cells. A calibration curve was constructed with 0-500 μg/L spinosad solutions by measuring absorbance at 250 nm. The prepared microcapsule suspension was filtrated with 0.02 μm disposable filter to remove microcapsules from the solution. The amount of encapsulated spinosad was calculated by subtracting the amount of unencapsulated spinosad from the initially added amount, and the encapsulation efficiency was calculated from the ratio of encapsulated spinosad to initially added amount.

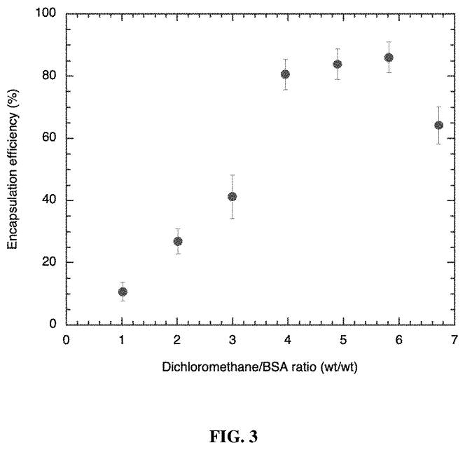

As indicated, a portion of spinosad migrates from dichloromethane droplets to the surrounding aqueous medium during the preparation process. The amount of escaped spinosad from emulsion droplets varies depending on the preparation conditions. To find an optimum condition for the preparation of spinosad encapsulated microparticles, the encapsulation efficiency of spinosad was examined for each sample used for the previous DLS experiment. The UV spectrum for spinosad showed a peak at 250 nm. Therefore, a calibration curve was constructed with this wavelength, and the concentration of unencapsulated spinosad was measured in each sample. The encapsulation efficiency was calculated by subtracting the amount of unencapsulated spinosad (mg) from the initial amount of spinosad (mg) then dividing that total by the initial amount of spinosad (mg) and multiplying that total by 100. Results are shown in FIG. 3. We concluded that the optimum conditions for the production of spinosad-containing microparticles is with 5%-6% emulsified droplets when 0.3% BSA is used.

### Example 2

Microcapsule Imaging, Adherence and Functional Evaluation

The microscope images of adsorbed microcapsules were taken from an inverted phase-contrast microscope (Carl Zeiss, Oberkocehn, Germany, model Axiovert 35) equipped with a digital camera. For this experiment, two slide glasses were coated with microcapsules by spraying the suspension on them and air-dried subsequently. After air-drying, one of them was examined as it was, and the other was rinsed with flowing water for 5 min.

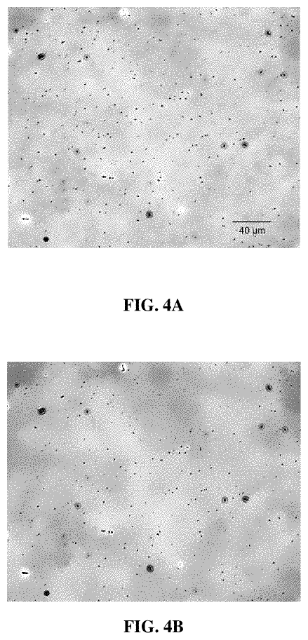

The surface of the spinosad microcapsules reported herein is covered with PECA chains. Therefore, these particles readily adhere to the surface of materials, including glass, metal, wood and plant material. In most cases, the contact angle of water on the surface plant leaves is too high to wet the plant leaves. Therefore, the sprayed pesticide solution forms droplets and roll down to the ground. Therefore, current commercial pesticides are sold as a mixture with other inactive ingredients to improve the wetting property. We resolved this issue, lowering the contact angle by dispersing the particles in aqueous ethanol solution. FIGS. 4A and 4B show microscopic images of two slide-glass plates coated with spinosad-containing microparticles. Both of them were sprayed with 30% aqueous ethanol in which microparticles were suspended. FIG. 4B shows the rinsing effect on the adsorbed microparticles. After rinsing with flowing water for 5 min, the density of the adsorbed particles was surprisingly only slightly lowered.

Use as a pesticide.

To determine effects of the microencapsulation process on spinosad functionality and to determine if the microcapsules could serve as pesticides resistant to washing away, the spinosad microcapsules were tested under laboratory conditions.

Corn earworms (Helicoverpa zea) and fall armyworms (Spodoptera frugiperda) were reared on pinto bean diet as described previously (Dowd, P. F., Pestic. Biochem. Physiol. (1988) 32:123-34). Cabbage loopers (Trichoplusia ni) were reared on similar diets and conditions (Behle, R. W., J. Econ. Entomol. (2006) 99:1120-26). First instar larvae were used for these analyses. Cabbage variety Bravo F1 (Harris Seeds, Rochester, N.Y.) was grown in the greenhouse under conditions reported previously (Behle, supra). The fifth leaf from the top, which was approximately 15 cm across, was used in the assays.

Potential differences in mortality of caterpillars were determined using leaf pieces as described previously (Dowd et al., J. Agric. Food Chem. (2012) 60:10768-75). Leaf pieces approximately 2×4 cm were obtained from directly opposite sides of the midvein in order to use equally aged portions of the leaf for corresponding assays. Approximately 50 μL of the microcapsule suspension in 30% ethanol was sprayed on 5 cm² plant leaves (approximately 25 μg spinosad/cm²). After one of the pair was treated to simulate rain wash off conditions and allowed to air dry, leaf pieces (washed and unwashed) were individually placed in 5 cm Petri dishes with tight-fitting lids (Falcon 351006). Twenty newly hatched caterpillars were added to each dish. The dishes were incubated in the dark under the same conditions used to rear the insects. Assays were checked for caterpillar mortality after one and two days.

The performance of prepared spinosad microcapsules was evaluated by using three different caterpillar pests of several crops: cabbage loopers, corn earworms and fall armyworms. All the tested caterpillars were killed within 48 hours on non-washed cabbage leaves treated with the spinosad-containing microcapsules. Surprisingly, all the tested caterpillars were killed within 24 hours on washed (i.e., imitation of rainfall) cabbage leaves treated with the spinosad-carrying microcapsules. There were no significant differences in mortality rates at P<0.05 by Chi square analysis. Results are shown in Table 1.

TABLE 1
Caterpillar mortality

| | Percent mortality | Percent mortality |
|---|---|---|
| Species | washed leaves | unwashed leaves |
| Day 1 | | |
| Cabbage loopers - experiment 1 | 100.0 | 100.0 |
| Cabbage loopers - experiment 2 | 100.0 | 100.0 |
| Corn earworms | 87.5 | 76.4 |
| Fall armyworms | 90.0 | 90.0 |
| Day 2 | | |
| Cabbage loopers - experiment 1 | 100.0 | 100.0 |
| Cabbage loopers - experiment 2 | 100.0 | 100.0 |
| Corn earworms | 100.0 | 100.0 |
| Fall armyworms | 100.0 | 100.0 |

### Example 3

Microcapsules were prepared essentially as described above, except using butyl acetate as the organic solvent and glycinin (a soy protein) as the shell material. Core materials (pesticides) in these microcapsules include Amdro® (hydramethylnon), malathion, diflubenzuron, allethrin, and carbaryl. Among these, hydramethylnon, diflubenzuron, and carbaryl are solid while malathion and allethrin are liquid at room temperature.

Butyl acetate was added to 10 g water while vigorously stirring the mixture until phase-separated droplets began to appear. 0.5 g of 5% pesticide solution in butyl acetate was added to the previously prepared butyl acetate/water mixture while stirring vigorously. Then, 0.5 g of 6% glycinin solution was added to this solution and stirred for 5 minutes. 4N hydrochloric acid was added to lower the pH of the solution to 2, and 30 μL of ECA was added subsequently. The reaction mixture was closed tightly and stirred overnight. This reaction yielded pesticide-containing microcapsule suspensions. The unencapsulated pesticide was removed by adding 1 g sodium chloride to the reaction product to induce aggregation of microcapsules. Then, it was centrifuged for 5 min at 10 k×g to separate the precipitates from the solution. The collected precipitates were suspended in 30% aqueous ethanol solution.

The prepared microcapsules from five pesticides were evaluated in the same way as described in the previous example, except leaves from sweet corn variety Kandy Korn (Livingston Seed Company, Columbus, Ohio) grown in a climate-controlled room under conditions reported previously (Dowd et al., J. Agric. Food Chem. (2012) 60:10768-75) were used. Surprisingly, all the tested fall armyworms were killed within 24 hours on washed (i.e., imitation of rainfall) leaves treated with the pesticide-carrying microcapsules. Results are shown in Table 2.

TABLE 2
Caterpillar mortality of Fall Armyworm on corn leaves after 24 hrs

| | Percent mortality | Percent mortality |
|---|---|---|
| Pesticide | washed leaves | unwashed leaves |
| Amdro ® | 100.0 | 100.0 |
| (hydramethylnon) | | |
| malathion | 100.0 | 100.0 |
| diflubenzuron | 100.0 | 100.0 |
| allethrin | 100.0 | 100.0 |
| carbaryl | 100.0 | 100.0 |

### Example 4

Microcapsules were prepared essentially as described above, except using butyl acetate as the organic solvent and BSA as the shell material. Core materials (pesticides) in these microcapsules include abamectin and spinetoram. Both abamectin and spinetoram are solid at room temperature.

Butyl acetate was added to 10 g water while vigorously stirring the mixture until phase-separated droplets began to appear. 0.5 g of 5% pesticide solution in butyl acetate was added to the previously prepared butyl acetate/water mixture while stirring vigorously. Then, 0.5 g of 6% BSA solution was added to this solution and stirred for 5 minutes. 4N hydrochloric acid was added to lower the pH of the solution to 2, and 30 μL of ECA was added subsequently. The reaction mixture was closed tightly and stirred overnight. This reaction yielded pesticide-containing microcapsule suspensions. The unencapsulated pesticide was removed by adding 1 g sodium chloride to the reaction product to induce aggregation of microcapsules. Then, it was centrifuged for 5 min at 10 k×g to separate the precipitates from the solution. The collected precipitates were suspended in 30% aqueous ethanol solution.

The prepared microcapsules from two pesticides were evaluated on the leaves from sweet corn and cabbage. All the tested fall armyworms were killed within 48 hrs on washed (i.e., imitation of rainfall) leaves treated with the pesticide-carrying microcapsules. Results are shown in Table 3.

TABLE 3
Caterpillar mortality of Fall Armyworm
on washed corn and cabbage leaves

Percent mortality

| Pesticide | Leaves | Day 1 | Day 2 |
|---|---|---|---|
| abamectin | Corn | 80.0 | 100.0 |
| abamectin | Cabbage | 95.0 | 100.0 |
| spinetoram | Corn | 100.0 | 100.0 |
| spinetoram | Cabbage | 90.0 | 100.0 |

While the invention has been described with reference to details of the illustrated embodiments, these details are not intended to limit the scope of the invention as defined in the appended claims. The embodiment of the invention in which exclusive property or privilege is claimed is defined as follows:

1. A composition comprising a microencapsulated organic compound, wherein the microencapsulated organic compound comprises a core material comprising the organic compound and a microcapsule having a protein shell wall surrounding the core material and wherein a degradable polymer is attached to the shell wall.

2. The composition of claim 1, wherein the organic compound is a pesticide.

3. The composition of claim 2, wherein the pesticide is an insect growth regulator, a chitin synthesis inhibitor, a macrocyclic lactone pesticide, an organophosphate pesticide, a carbamate pesticide, or a pyrethroid pesticide.

4. The composition of claim 2, wherein the pesticide is selected from the group consisting of abamectin, spinosad, spinetoram, hydramethylnon, malathion, diflubenzuron, allethrin, carbaryl, and mixtures thereof.

5. The composition of claim 1, wherein the organic compound is a solid that does not dissolve in water and is soluble in an organic solvent, wherein said organic solvent is not miscible in water.

6. The composition of claim 1, wherein the organic compound is a liquid that does not mix with water.

7. The composition of claim 1, wherein the protein comprises a protein from plant, animal, microbial, or synthetic origin.

8. The composition of claim 1, wherein the protein is bovine serum albumin or glycinin.

9. The composition of claim 1, wherein the degradable polymer comprises poly(alkyl cyanoacrylate).

10. The composition of claim 9, wherein the organic solvent is water-immiscible.

11. The composition of claim 9, wherein the organic solvent is dichloromethane or butyl acetate.

12. Microparticles comprising an organic compound core material microencapsulated in a protein shell wall, wherein a degradable polymer is attached to the shell wall, said microparticles produced by a method comprising:
a. preparing a solution of the organic compound in a first organic solvent to produce a solution of the organic compound;
b. adding a second organic solvent to water and stirring the mixture to saturate the water with the second organic solvent;
c. adding the solution of the organic compound to said water saturated with the second organic solvent to generate phase-separated droplets;
d. adding a protein solution to the phase-separated droplets under conditions effective to encapsulate the droplets by the protein, thereby forming a protein shell wall;
e. adding monomers of the degradable polymer to the protein-encapsulated droplets under conditions effective to allow formation of the degradable polymer attached to the protein shell wall; and
f. recovering said microparticles.

13. The method of claim 12, wherein the first and second organic solvents are the same organic solvent.

14. The method of claim 12, wherein the first organic solvent is dichloromethane or butyl acetate.

15. The method of claim 12, wherein the organic compound is a pesticide.

16. The composition of claim 15, wherein the pesticide is an insect growth regulator, a chitin synthesis inhibitor, a macrocyclic lactone pesticide, an organophosphate pesticide, a carbamate pesticide, or a pyrethroid pesticide.

17. The method of claim 15, wherein the pesticide is selected from the group consisting of abamectin, spinosad, spinetoram, hydramethylnon, malathion, diflubenzuron, allethrin, carbaryl, and mixtures thereof.

18. The method of claim 12, wherein the protein comprises a protein from plant, animal, microbial, or synthetic origin.

19. The method of claim 12, wherein the protein is bovine serum albumin or glycinin.

20. The method of claim 12, wherein the degradable polymer comprises poly(alkyl cyanoacrylate).

21. A method of making the microencapsulated organic compound of claim 1, comprising the steps of:
a. preparing a solution of the organic compound in a first organic solvent to produce a solution of the organic compound;
b. adding a second organic solvent to water and stirring the mixture to saturate the water with the second organic solvent;
c. adding the solution of the organic compound to said water saturated with the second organic solvent to generate phase-separated droplets;
d. adding a protein solution to the phase-separated droplets under conditions effective to encapsulate the droplets by the protein, thereby forming a protein shell wall;
e. adding monomers of the degradable polymer to the protein-encapsulated droplets under conditions effective to allow formation of the degradable polymer attached to the protein shell wall; and
f. recovering said microparticles.

22. The method of claim 21, wherein the first and second organic solvents are the same organic solvent.

23. The method of claim 21, wherein the first organic solvent is dichloromethane or butyl acetate.

24. The method of claim 21, wherein the organic compound is a pesticide.

25. The composition of claim 24, wherein the pesticide is an insect growth regulator, a chitin synthesis inhibitor, a macrocyclic lactone pesticide, an organophosphate pesticide, a carbamate pesticide, or a pyrethroid pesticide.

26. The method of claim 24, wherein the pesticide selected from the group consisting of abamectin, spinosad, spinetoram, hydramethylnon, malathion, diflubenzuron, allethrin, carbaryl, and mixtures thereof.

27. The method of claim 21, wherein the protein comprises a protein from plant, animal, microbial, or synthetic origin.

28. The method of claim 21, wherein the protein is bovine serum albumin or glycinin.

29. The method of claim 21, wherein the degradable polymer comprises poly(alkyl cyanoacrylate).

30. A method of killing an insect, comprising the steps of
a. applying the microencapsulated pesticide of claim 2 to a plant surface, thereby adsorbing the microencapsulated pesticide to the plant surface; and
b. allowing an insect to ingest or absorb the microencapsulated pesticide in an effective amount to kill the insect.

31. The method of claim 30, wherein the pesticide is an insect growth regulator, a chitin synthesis inhibitor, a macrocyclic lactone pesticide, an organophosphate pesticide, a carbamate pesticide, or a pyrethroid pesticide.

32. The method of claim 30, wherein the pesticide is selected from the group consisting of abamectin, spinosad, spinetoram, hydramethylnon, malathion, diflubenzuron, allethrin, carbaryl, and mixtures thereof.

33. The method of claim 30, wherein the plant surface selected from the group consisting of a leaf surface, a stem surface, a flower surface, a root surface, a tuber surface, or a seed surface.

34. The method of claim 30, wherein exposure of the plant surface to water following adsorption of the microencapsulated pesticide does not result in removal of the effective amount of the microencapsulated pesticide.
